(19) United States
(12) Patent Application Publication
(10) Pub. No.: US 2014/0022900 A1
(43) Pub. Date: Jan. 23, 2014

(54) SYSTEM AND METHOD FOR INDICATING A LEVEL OF RAN CONGESTION FOR USER PLANE TRAFFIC IN A NETWORK ENVIRONMENT

(71) Applicants: Nirav Salot, Pune (IN); Lionel Florit, Greenbrae, CA (US); Maulik Vaidya, Alpharetta, GA (US)

(72) Inventors: Nirav Salot, Pune (IN); Lionel Florit, Greenbrae, CA (US); Maulik Vaidya, Alpharetta, GA (US)

(73) Assignee: Cisco Technology, Inc.

(21) Appl. No.: 13/551,374

(22) Filed: Jul. 17, 2012

(51) Int. Cl. H04W 28/02

(52) U.S. Cl. 370/235

(57) ABSTRACT

A method is provided in one example embodiment and includes receiving by a first network element a data packet associated with a subscriber. The method further includes determining a level of radio congestion currently experienced by the subscriber and encapsulating the data packet in accordance with a first protocol, the encapsulating comprising adding a header to the data packet, the header including an extension header that includes a congestion level indicator (“CLI”) indicative of the determined level of radio congestion. The encapsulated data packet is forwarded to a second network element. The extension header further includes an indication of whether the radio congestion currently experienced by the subscriber is in an uplink direction or a downlink direction.

### TECHNICAL FIELD

This disclosure relates in general to the field of communications and, more particularly, to indicating a level of RAN congestion for user plane traffic in a network environment.

### BACKGROUND

Although the data capacity of 3GPP networks has increased significantly since its initial development, user traffic continues to outpace the growth in capacity, resulting in increased network congestion and degraded user service. In particular, the explosion of Internet data traffic, especially the growing portion of the traffic traversing mobile networks, has caused much of the congestion currently being experienced. This explosion is partly attributable to the increase in the number of users using smart phone devices possessing 3G/4G capabilities together with large screens and various Internet applications, such as browsers and video and audio streaming applications. Additionally, laptops and tablets with 3G/4G access capabilities are a major source of mobile data traffic. An annual growth rate of 50% is expected to continue, with growth likely to continue outpacing the increase in infrastructure needed to handle it.

A primary point of congestion in 3GPP networks is the radio access network (“RAN”) nodes (e.g., radio network controllers (“RNCs”) or eNodeBs). In particular, because radio spectrum is most expensive resource for a local authority to acquire and control, it is difficult for an operator to easily upgrade its radio capacity. Hence, the radio congestion for user plane traffic is effectively unavoidable. During periods of radio congestion due to user plane traffic, the RAN nodes may attempt to throttle, or limit, user data packets based on the quality of service (“QoS”) profile of the radio bearer; however, RAN nodes are unable to provide application-based differential treatment. Moreover, user data packets are not throttled by RAN nodes until after those packets have already traversed the network between the PDN gateway (“PGW”) and the RAN nodes, resulting in inaccurate accounting and unnecessary increase in backhaul load.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for indicating a level of RAN congestion for user plane traffic in a network environment in accordance with one embodiment of the present disclosure;

FIG. 2 is a simplified block diagram of a communication system similar to the communication system shown in FIG. 1 illustrating a state of RAN congestion for one or more subscribers;

FIG. 3 is a block diagram of a GTPv1-U Protocol Stack in accordance with one embodiment of the present disclosure;

FIG. 4 is a block diagram of the format of the Header of the GTPv1-U Protocol Stack of FIG. 3 in accordance with one embodiment of the present disclosure;

FIG. 5 is a block diagram of the GTPv1-U Extension Header General Format of the Header of FIG. 4 in accordance with one embodiment of the present disclosure;

FIG. 6 is a block diagram of the format for the Congestion Level Indicator of the GTPv1-U Extension Header in accordance with one embodiment of the present disclosure;

FIG. 7 is a flowchart illustrating RAN congestion level indication (“RCLI”) logic executed at a RAN node for indicating a radio congestion level for a particular subscriber in accordance with one embodiment of the present disclosure; and

FIG. 8 is a flowchart illustrating RAN congestion level indication (“RCLI”) logic executed at a PDN gateway (“PGW”) for correcting a congestion state for a particular subscriber in accordance with one embodiment of the present disclosure.

### DETAILED DESCRIPTION OF EXAMPLE EMBODIMENTS

### Overview

A method is provided in one example embodiment and includes receiving by a first network element a data packet associated with a subscriber. The method further includes determining a level of radio congestion currently experienced by the subscriber and encapsulating the data packet in accordance with a first protocol, the encapsulating comprising adding a header to the data packet, the header including an extension header that includes a congestion level indicator (“CLI”) indicative of the determined level of radio congestion. The encapsulated data packet is forwarded to a second network element. The extension header further includes an indication of whether the radio congestion currently experienced by the subscriber is in an uplink direction or a downlink direction.

The method can further include receiving the encapsulated data packet at the second network element. The second network element evaluates the encapsulated data packet to determine the CLI and initiates corrective action to reduce the level of radio congestion experienced by the subscriber based on the CLI. The corrective action may include one of throttling subscriber data traffic associated with a particular application to improve quality of experience (“QoE”) of other applications, offloading subscriber data traffic to a complementary network, causing a server comprising at least one of an application server and a content server to change an encoding rate for the subscriber data traffic, requesting the subscriber to upgrade its subscription, and downgrading a subscription levels of other subscribers in a same cell as the subscriber.

### EXAMPLE EMBODIMENTS

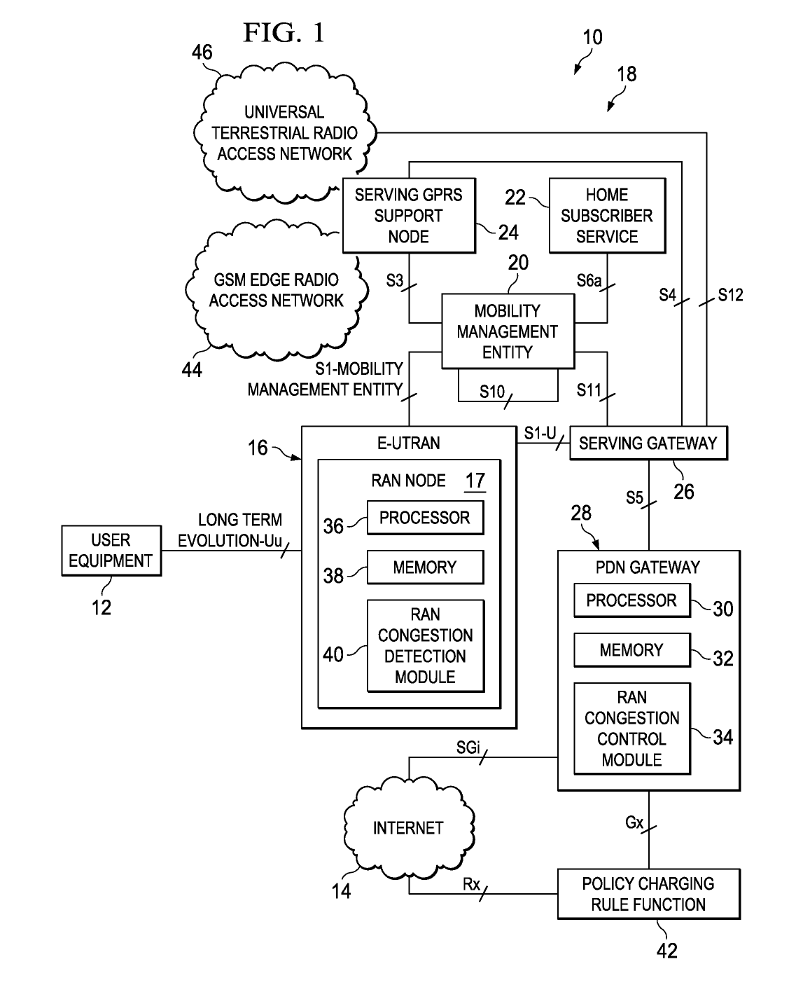

Turning to FIG. 1, FIG. 1 is a simplified block diagram of a communication system 10 for indicating a level of RAN congestion for user plane traffic in a network environment in accordance with one embodiment of the present disclosure. As illustrated in FIG. 1, communication system 10 may include user equipment (“UE”) 12 that may be connected to communicate data to and from the Internet 14 via a radio access network (“RAN”) 16 comprising a plurality of RAN nodes, represented in FIG. 1 by a RAN node 17, and a core network 18. In one embodiment, the RAN 16 is implemented as an E-UTRAN, in which the RAN nodes comprise eNodeBs; however, it will be recognized that the RAN 16 may also be implemented using radio network controllers (“RNCs”) instead of or in addition to eNodeBs for the RAN nodes. In one embodiment, the core network 18 may be implemented using an Evolved Packet Core (“EPC”) network as defined in 3GPP TS 23.401 and employing a user plane protocol GTPv1-U. It will be understood, however, that other implementations of the core network 18 may be employed in accordance with the features described herein.

As illustrated in FIG. 1, the core network 18 may include a mobility management entity (“MME”) 20, which is responsible for control plane functions related to subscriber and session management and is connected to a home subscriber service (“HSS”) 22, which supports a database that includes user subscription information, through an S6a interface. The core network 18 may further include a serving GPRS support node (“SGSN”) 24 connected to the MME 20 via an S3 interface for providing functionality related to packet-data switching.

The core network 18 may further include a serving gateway (“SGW”) 26, which is the termination point of the user plane interface S1-U toward the RAN network 16, and a PDN gateway (“PGW”) 28, which supports policy enforcement features that apply operator-defined rules for resource allocation and usage, as well as packet filtering and inspection and charging support. For purposes that will be described in greater detail below, the PGW 28 includes a processor 30, memory 32, and a RAN congestion control 34 for implementing RAN congestion level detection for user plane traffic functionality in accordance with features of embodiments described herein. Similarly, for purposes that will be described in greater detail below, the representative RAN node 17 includes a processor 36, memory 38, and a RAN congestion detection module 40 for implementing RAN congestion level detection for user plane traffic functionality in accordance with features of embodiments described herein. The PGW 28 may interface with a policy charging rule function (“PCRF”) 42, which manages the service policy and provides QoS information for each user session. It will be recognized that the core network 18 may provide a variety of functionality in communication system 10, including, for example, one or more of aggregation, user authentication, call control and switching, accounting and charging, service invocation, and gateways.

MME 20 also provides the control plane function for mobility between LTE and 2G/3G access networks, such as GSM Edge Radio Access Network (“GERAN”) 44 and Universal Terrestrial Radio Access Network (“UTRAN”) 46, with the S3 interface, terminating at MME 20 from the SGSN 24. GERAN 44 is the radio part of GSM/EDGE together with the network that joins the base stations, or Node Bs, and the base station controllers (“BSCs”). GERAN comprises the core of a GSM network through which phone calls and packet data are routed to and from the PSTN and the Internet to and from UE. A mobile phone operator's network comprises one or more GERANs, coupled with UTRANs, in the case of a UMTS/GSM network. UTRAN refers to the Node B's and that make up the Universal Mobile Telecommunications System (“UMTS”) radio access network. UTRAN can carry many traffic types from real-time Circuit Switched to IP based Packet Switched. UTRAN enables connectivity between UE and a core network. UTRAN includes multiple Node Bs and several RNCs, each of which provides control functionalities for one or more Node Bs. A Node B and an RNC can be collocated on a single device; however, they are typically implemented separately, with the RNC disposed in a central location for serving multiple Node Bs. The RNC and its corresponding Node Bs are called the Radio Network Subsystem (RNS). A single UTRAN may include more than one RNS.

In one embodiment, communication system 10 is implemented in accordance with the Long-Term Evolution (“LTE”) standard. E-UTRAN provides the radio access in the LTE network and is designed to improve end-user throughputs and sector capacity and reduce user plan latency, bringing significantly improved user experience with full mobility. With the emergence of IP as the protocol of choice for all types of traffic, LTE provides support for IP-based traffic with end-to-end QoS. E-UTRAN supports various types of services, including web browsing, FTP, video streaming, VoIP, online gaming, real time video, push-to-talk, and push-to-view, for example.

UE 12 can be associated with clients, customers, or end users wishing to initiate a communication in communication system 10 via some network. The term ‘user equipment’ is inclusive of devices used to initiate a communication, such as a computer, a personal digital assistant (PDA), a laptop or electronic notebook, a cellular telephone, an iPhone, an iPad, an IP phone, or any other device, component, element, or object capable of initiating voice, audio, video, media, or data exchanges within communication system 10. UE 12 may also be inclusive of a suitable interface to the human user, such as a microphone, a display, or a keyboard or other terminal equipment. UE 12 may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another. On power up, UE 12 can be configured to initiate a request for a connection with a service provider. A user agreement can be authenticated by the service provider based on various service provider credentials (e.g., subscriber identity module (“SIM”), Universal SIM (“USIM”), certifications, etc.). More specifically, a device can be authenticated by the service provider using some predetermined financial relationship.

In general terms, SGW 26 is associated with an SGSN user plane in an IP network. SGW 26 can be configured to route and to forward user data packets, while also acting as the mobility anchor for the user plane during inter-Node B handovers. Additionally, SGW 26 can act as the anchor for mobility between LTE and other 3GPP technologies (i.e., terminating the S4 interface and relaying the traffic between 2G/3G systems and PGW 28 via the S5 interface). For idle-state UEs, SGW 26 can terminate the data path and trigger paging when data arrives for UE 12. SGW 26 can also manage and store UE contexts (e.g., parameters of the IP bearer service, network internal routing information, etc.).

MME 20 can be configured to operate as a control node for the LTE access-network. It further can be responsible for idle mode UE tracking and paging procedures (e.g., including retransmissions). Furthermore, MME 20 can be involved in the bearer activation/deactivation process and can be responsible for choosing SGW 26 for UE 12 at the initial attach (and at time of an intra-LTE handover involving core network node relocation). MME 20 can also be responsible for authenticating the user. MME 20 also provides the control plane function for mobility between LTE and 2G/3G access networks, such as GSM Edge Radio Access Network (“GERAN”) 44 and Universal Terrestrial Radio Access Network (“UTRAN”) 46, with the S3 interface, terminating at MME 20 from the SGSN 24.

In regard to particular applications involving UE 12, media servers comprising one or more video servers, which can provide streaming video to an individual associated with UE 12 via the Internet 14. For example, an individual could be uploading (or streaming) video over the network to which UE 12 is connected. This could involve technologies such as flip video, webcams, YouTube, and various other video technologies involving any type of uploading and/or streaming video data.

For purposes of illustrating certain example techniques of communication system 10, it is important to understand the communications that may be traversing the network and the congestion that can be caused at various points by such communications. In particular, after a subscriber data session has been established in a conventional fashion between the UE 12 and the Internet 14, data packets from the UE 12 are encapsulated by the RAN node 17 in accordance with GTPv1-U and forwarded on to SGW 26/PGW 28. The SGW 26/PGW 28 decapsulates the user data packets from GTPv1-U tunnel between the RAN node 17 and the SGW 26/PGW 28 and forwards it to Internet 14. Conversely, data packets intended for the UE 12 are transmitted to the UE from the Internet 14 via the PGW 28/SGW 26, which encapsulates the same in accordance in GTPv1-U tunnel towards the RAN node, and the RAN node 17 decapsulates the data packets upon receipt thereof.

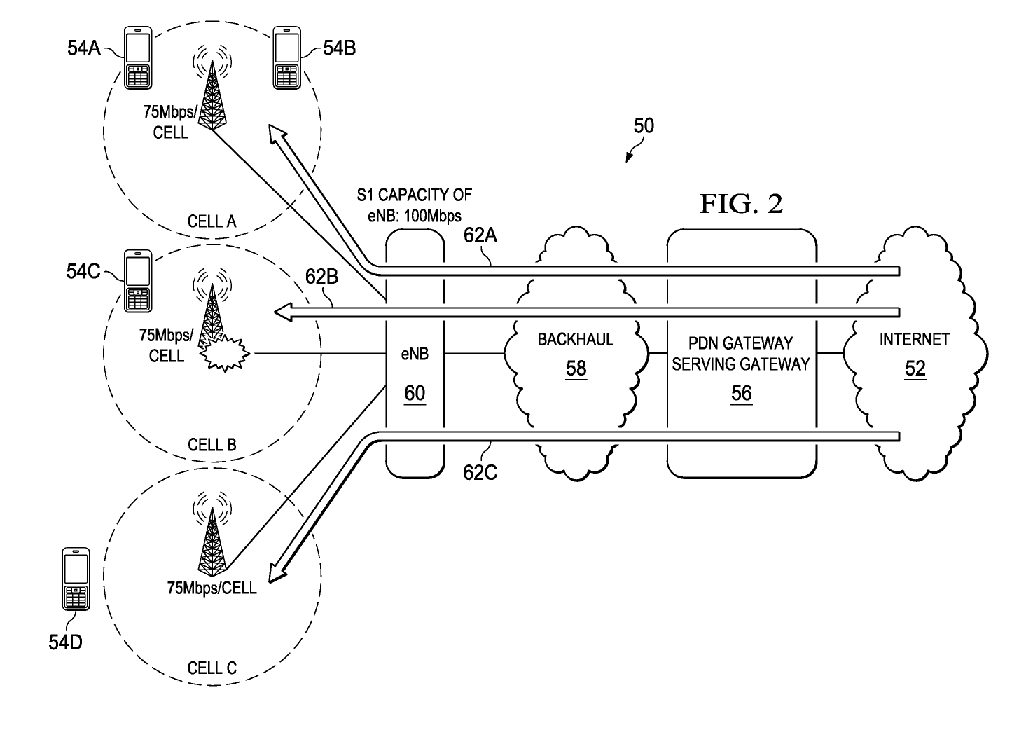

Referring now to FIG. 2, illustrated therein is a simplified block diagram of a network 50, which is similar to communication system 10 except that RCLI functionality is not implemented in the network 50. In one example, using the network 50, downlink traffic from the Internet 52 and destined for one of a plurality of UEs 54A-54D traverses a PGW/SGW 56 and a backhaul network 58 to a RAN node comprising an eNodeB 60. The eNodeB 60 is in communication with a plurality of cells A-C, each of which service one or more of the UEs 54A-54D. As shown in FIG. 2, traffic destined for cell A is represented by an arrow 62A, traffic destined for cell B is represented by an arrow 62B, and traffic destined for cell C is represented by an arrow 62C. It will be assumed for the sake of example that the radio capacity of each cell A-C is 75 Mbps, while the S1 capacity of the eNodeB 60 is 100Mbps. Accordingly, assuming downlink data traffic destined for cell A is 100Mbps, one or more subscribers at UE 54C will experience RAN congestion for the user plane traffic. Such a subscriber will hereinafter be referred to as a “RAN congested subscriber.” Currently, the situation is managed by the RAN node throttling traffic based solely on the QoS profile of the radio bearer. This method is deficient in that it fails to take into account the type of application traffic; in other words, it does not provide an application-specific approach to congestion control. Hence, the subscriber will observe a deterioration of Quality of Experience (“QoE”) across all the applications the subscriber is using. For example, if the subscriber is simultaneously watching a YouTube video and downloading a file using a file transfer protocol (“FTP”) application, the subscriber will experience same level of deterioration of QoE for both of the applications. Additionally, it fails to alleviate congestion in the backhaul network and results in inaccurate accounting, as the subscriber will have already been billed for data packets that end up being discarded at the RAN node.

Communication system 10 can address these issues (and others) in offering PGW-based RAN congestion control of user plane traffic. Such a RAN congestion control system would allow for application-specific congestion control based on operator policy. For example, operator policy may provide that during periods of RAN congestion, Facebook video traffic should be throttled to maintain a high QoE for other applications used by the subscribers. Additionally, such a RAN congestion control system would allow for, during heavy RAN congestion, offloading traffic to a complementary network. Mobile data offloading involves the use of complementary network technologies for delivering data originally targeted for a cellular network. The primary complementary network technologies currently employed for mobile data offloading are WiFi, Femtocell, and Integrated Mobile Broadcast (“IMB”). In general, rules governing the triggering of mobile data offloading may be set by an end-user or an operator. The code for implementing the rules may be resident on UE or a server or may be divided between the two. For end-users, the benefit of mobile data offloading is that it helps control the cost of data service and in most cases, takes advantage of the higher bandwidth that may be available with the complementary network technology. For operators, the benefit of mobile data offloading is the ability to ease congestion in cellular networks as it arises. It is anticipated that other complementary technologies will be developed, due to the continuous surge of mobile data; therefore, when used herein, the term “offloading” is intended to encompass offloading of mobile data using any such complementary technology, whether or not currently in existence.

Access Network Discovery and Selection Function (“ANDSF”) is currently a preferred 3GPP approach for controlling offloading between 3GPP and non-3GPP access networks (such as Wi-Fi). The purpose of the ANDSF is to assist user devices to discover access networks in their vicinity and to provide rules (policies) to prioritize and manage connections to all networks.

Using the above-described offloading technology, the RAN congestion control system may trigger a change in Inter-System Routing Policies (“ISRP”) via eANDSF to offload a user session or application flow pertaining to specific service, such as YouTube or Facebook video, to a nearby WiFi network. In another example, the user session could be offloaded to a Femtocell. In this manner, communication system 10 also provides for more accurate accounting and charging functionality than an approach in which data is throttled at the RAN node during a congestion condition, due to the fact that application-aware intelligent congestion control takes place at the PGW rather than at the RAN node, which cannot perform such an operation, as described in greater detail below. Finally, the communication system 10 also provides congestion control for downlink traffic at the edge of the core network 18, thereby preventing overloading of the backhaul network because traffic is throttled before entering the backhaul network.

Referring again to FIG. 1, in a manner that will be described in greater detail below, in communication system 10, the RAN congestion control module 34 at the PGW 28 monitors the uplink data traffic to determine whether the subscriber associated with UE 12 is experiencing RAN congestion in uplink or downlink direction; that is, whether the subscriber is a RAN congested subscriber. In accordance with features of one embodiment, the RAN congestion detection module 40 at the RAN node 17 determines for each subscriber whether the subscriber is a congested subscriber and marks uplink GTPv1-U packets of each congested subscriber in a manner to be described in greater detail below to enable the PGW 28 to identify the subscriber session experiencing the congestion and to take appropriate remedial action. The marking of the uplink GTPv1-U packets is achieved using a newly-defined GTPv1-U extension header type, referred to as the RAN Congestion Level Indicator (“RCLI”) extension header. The RCLI extension header contains a value representing the RAN congestion level, for user plane traffic, currently being experienced by the subscriber and the direction of any such congestion.

Based on operator policy as defined in the PCRF 42, the PGW 28 can apply appropriate congestion control action based on the value of the RCLI. As will be described in greater detail below, such action may include, for example, application-specific activities, such as throttling Facebook video for a period of time, or may include triggering a change in IRSP (via eANDSF), to offload designated traffic to a complementary network technology, such as a WiFi network. As a result, RAN congestion can be eased without deterioration of user experience for other applications.

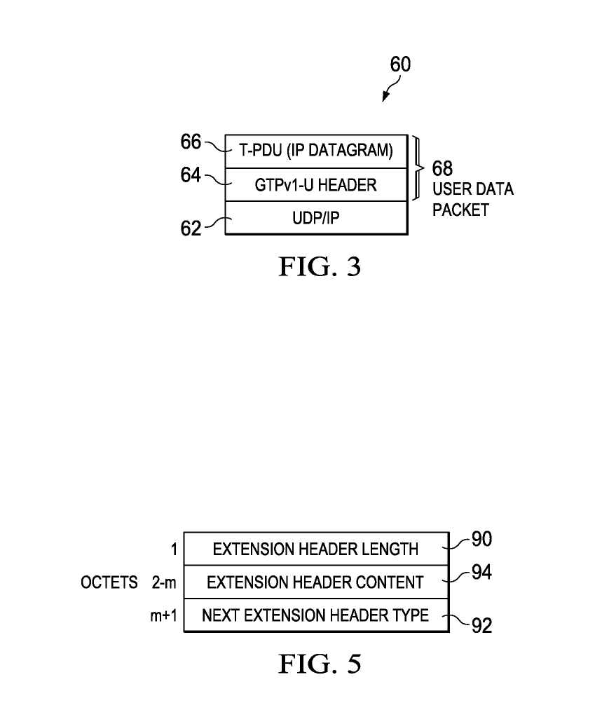

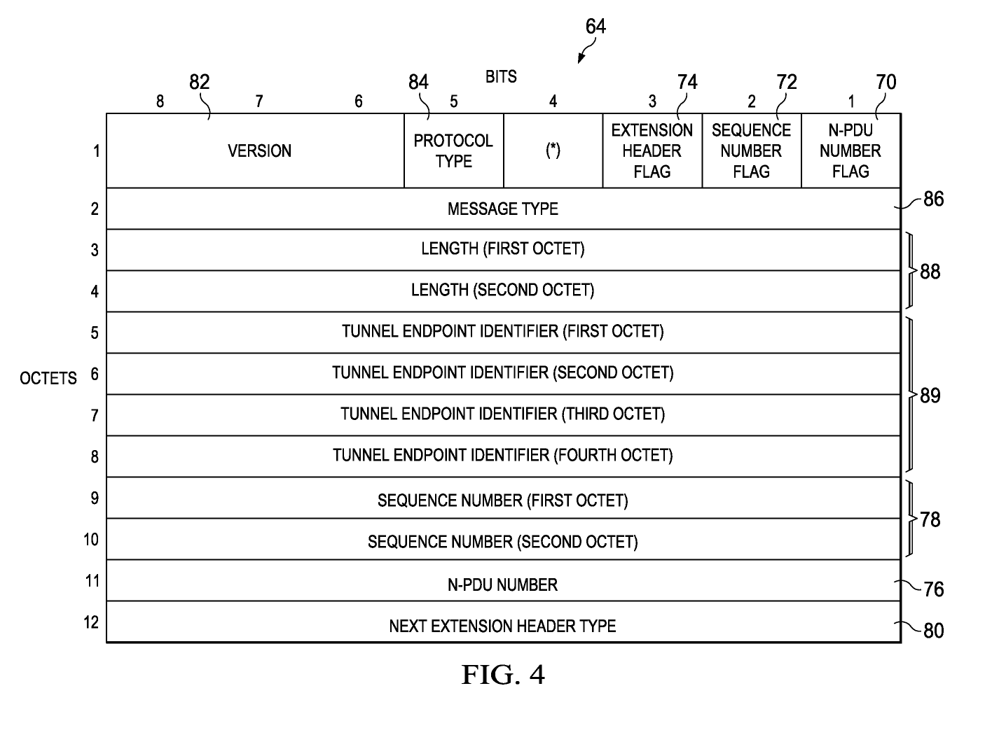

FIG. 3 illustrates a GTPv1-U Protocol Stack 60 for user data. The stack 60 includes UDP/IP 62, a GTPv1-U header 64, and a T-PDU (IP datagram) 66. Together the header 64 and datagram 66 form a user data packet, or G-PDU 68. FIG. 4 illustrates the format of the GTPv1-U header 64. The GTPv1-U header is a variable length header, the minimum length of which is 8 bytes. The header 64 includes three flags the states of which are used to signal the presence of additional optional fields: an N-PDU Number flag (“PN”) 70, a Sequence Number flag (“S”) 72, and an Extension Header flag (“E”) 74. The PN flag 70 is used to signal the presence of an N-PDU Numbers field 76. The Sequence Number flag 72 is used to signal the presence of a GTP Sequence Number Field 78. The Extension Header flag 74 is used to signal the presence of a meaningful value in a Next Extension Header Type field 80. The Next Extension Header Type field 80 is used to enable extensions of the GTPv1-U header 64. The N-PDU Numbers field 76, the GTP Sequence Number field 78, and the Next Extension Header Type field 80 will be present in the GTPv1-U header 64 if and only if its corresponding flag 70, 72, 74 is set. The sender sets all bits of unused fields to zero. The receiver does not evaluate the unused fields.

Certain fields of the header 64 are always present. In particular, a Version field 82 is used to indicate the version of the GTP-U protocol being used. In the header 64, the version number is set to “1”. A Protocol Type (“PT”) field 84 is used as a protocol discriminator GTP (PT set to “1”), which is described in 3GPP TS 29.281 and GTP' (PT set to “0”), which is described in 3GPP TS 32.295. Interpretation of header fields may be different in GTP'.

As described above, the Extension Header flag (“E”) 74 indicates the presence of a meaningful value of a Next Extension Header Type field 80. When E is set to “0”, the Next Extension Header Type field 80 either is not present or, if present, will not be interpreted. When E is set to “1”, the Next Extension Header Type field 80 is present and will be interpreted, as described below. As also indicated above, the Sequence Number flag (“S”) 72 indicates the presence of a meaningful value of the Sequence Number field 78. When S is set to “0”, the Sequence Number field 78 is either not present or, if present, will not be interpreted. Since the use of Sequence Numbers is optional for G-PDUs, the PGW, SGW and eNodeB should set the S flag to “0”. When a G-PDU (T-PDU+header) is being relayed by the Indirect Data Forwarding for Inter RAT HO procedure, then if the received G-PDU has the S flag set to ‘1’, then the relaying entity should set S flag to ‘1’ and forward the G-PDU (T-PDU+header). As also descried above, the N-PDU Number flag (“PN”) 70 indicates the presence of a meaningful value of the N-PDU Number field 76. When PN is set to “0”, the N-PDU Number field 76 either is not present, or, if present, will not be interpreted. When PN is set to “1”, the N-PDU Number field 76 is present, and will be interpreted, as described below.

A Message Type field 86 indicates the type of GTP-U message associated with the header. A Length field 88 indicates the length in octets of the payload, i.e. the rest of the packet following the mandatory part of the GTP header comprising the first eight octets. The N-PDU Number, the Sequence Number, or any Extension Header fields 76, 78, 80, are considered to be part of the payload and included in the length count. The value in a Tunnel Endpoint Identifier (“TEID”) field 89 unambiguously identifies a tunnel endpoint in the receiving GTP-U protocol entity. The receiving end side of a GTP tunnel locally assigns the TEID value the transmitting side has to use. The value in the TEID field 89 is used by the receiving entity to find the PDP context/EPS Bearer, except for Echo Request/Response and Supported Extension

Headers notification and Error Indication messages, in which cases the value in the TEID field 89 is set to all zeros. The Next Extension Header Type field 80 defines the type of Extension Header that follows the field in the G-PDU 68.

The general format of the GTPv1-U Extension Header is depicted in FIG. 5. A value in an Extension Header Length field 90 indicates the length of the corresponding extension header in four octet units. The length of the extension header is defined in a variable length of four octet units; that is m+1=n*4 octets, where n is a positive integer. A value in a Next Extension Header Type field 92 specifies the type of any extension header that may follow the current extension header, allowing for chaining of extension headers. Content of the extension header is indicated in a variable-length Extension Header Content field 94.

Bits 7 and 8 of the value in the Next Extension Header Type field 92 define how a recipient handles unknown extension header types. The recipient of an extension header of unknown type marked “comprehension not required” for that recipient reads the value in the Next Extension Header Type field 92, using the value in the Extension Header Length field to identify the location of the Net Extension Header Type field 92 in the G-PDU. The recipient of an extension header of unknown type that is marked “comprehension required” for that recipient should take one of the following actions. If the message with the unknown extension header was a request, the recipient should send a response message back with CAUSE set to “unknown mandatory extension header”; send a Supported Extension Headers notification to the originator of the GTP PDU; or log an error.

The meanings of bits 7 and 8 of the next extension header type are defined in Table 1 below.

TABLE 1

| it 8 | it 7 | Meaning |
|---|---|---|
| | | Comprehension of this extension header is not required; an |
| | | intermediate node must forward it to a receiver endpoint. |
| | | Comprehension of this extension header is not required. An |
| | | intermediate node must discard the extension header content and |
| | | not forward it to any receiver endpoint. Other extension |
| | | headers will be treated independently of this extension header. |
| | | Comprehension of this extension header is required by the |
| | | endpoint receiver but not by an intermediate node. An |
| | | intermediate node must forward the whole field to the endpoint |
| | | receiver. |
| | | Comprehension of this extension header is required by the |
| | | recipient, whether the recipient is an endpoint receiver or an |
| | | intermediate node. |

An endpoint receiver, which may be an RAN node, for example, is the ultimate receiver of the GTP-PDU.

The different extension header types, as currently defined by 3GPP in 3GPP TS 29.281, are provided in Table 2 below.

TABLE 2

| Next Extension | |
|---|---|
| Header Field Value | Type of Extension Header |
| 0000 0000 | No more extension headers |
| 0000 0001 | Reserved-Control Plane Only |
| 0000 0010 | Reserved-Control Plane Only |
| 0100 0000 | UDP Port-provides the UDP source port |
| | of the triggering message |
| 1100 0000 | PDCP PCU number [4]-[5] |
| 1100 0001 | Reserved-Control Plane Only |
| 1100 0010 | Reserved-Control Plane Only |

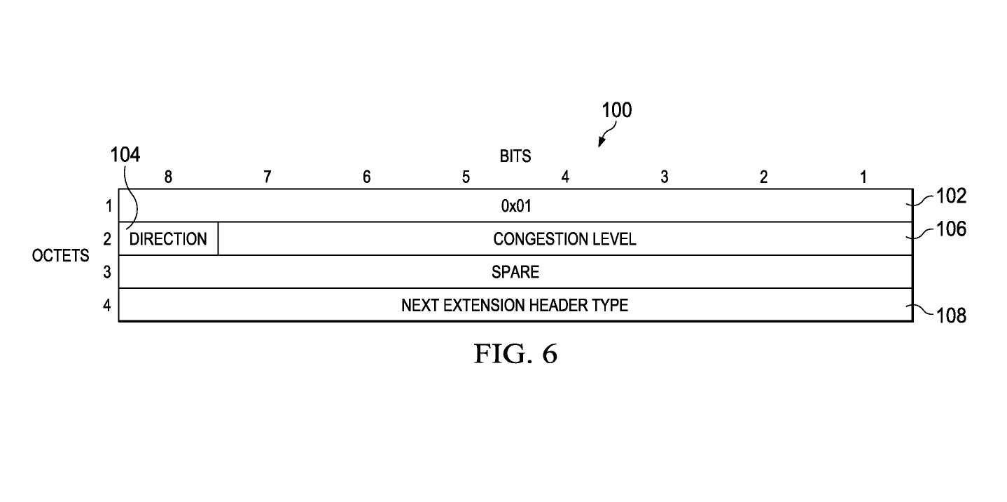

In accordance with features of one embodiment, a new type of extension header is defined and designated a Congestion Level Indicator (“CLI”). In one embodiment, setting the value of the Next Extension Header Type field to 0000 1000 indicates that the next extension header is a CLI. FIG. 6 is a diagram of a GTPv1-U extension header type 100 comprising a Congestion Level Indicator (“CLI”). As shown in FIG. 6, the first octet 102 of the CLI 100 is set to 0x01. The CLI 100 comprises a one bit Direction field 104. If the value of the Direction field is set to “0”, the congestion information contained in the CLI 100 relates to downlink congestion information. Conversely, if the value of the Direction field is set to “1”, the congestion information contained in the CLI 100 relates to uplink congestion information. The CLI 100 further includes a Congestion Level field 106, which in the illustrated embodiment is an seven-bit field. The value contained in the Congestion Level field 106 indicates a level of radio congestion of the link (either uplink or downlink, depending on the value in the Direction field 104). In the illustrated embodiment, the range of values that the Congestion Level field 106 may contain is from zero, which corresponds to a condition in which no congestion exists in the link, to 100, which corresponds to a condition in which maximum congestion exists in the link. Although congestion level values of 0-100 have been described, it will be recognized that a less granular range of congestion level values, such as a range of 0-10 or 0-1, may also be advantageously employed.

The value in the Congestion Level field 106 is assessed at the PGW 28 and used to determine what type of corrective action to take for “application-aware intelligent congestion control” in connection with the congested subscriber. Examples of corrective action include throttling certain types of application data for a certain period of time or temporarily offloading the data traffic the data to a complementary network technology. For example, the PGW 28 may block or throttle traffic related to a particular service, such as YouTube video or Facebook video, for a particular period of time to reduce the amount of congestion being experienced by the subscriber for other applications. The PGW may feed the congestion level information to a video content server to request the video content server to change the encoding rate to adapt to the current congestion level; for example, during periods in which a subscriber is experiencing relatively little congestion, higher encoding rates can be used by the video content server, whereas during periods in which the subscriber is experiencing relatively high congestion, lower encoding rates can be used by the video content server, and thus the amount of bandwidth needed to transfer the content can be dynamically controlled by the current level of RAN congestion. In another alternative, the congested subscriber can be requested to upgrade its subscription level or top-up its subscription to a level that ensures better QoE than its current subscription level, to avail itself of an instant speed boost. In yet another alternative, if the PGW knows the identity of other subscribers in the same cell in which the congested subscriber is located, the PGW can change (specifically, downgrade) the QoS of those other subscribers (who are subscribed to lower subscription level than the congested subscriber) to ease congestion for the congested subscriber in the cell.

The CLI extension header 100 further includes a Next Extension Header Type field 108. This field 108 is similar to the field 92 (FIG. 5) in that a value in a Next Extension Header Type field 108 specifies the type of any extension header that may follow the current extension header, allowing for chaining of extension headers.

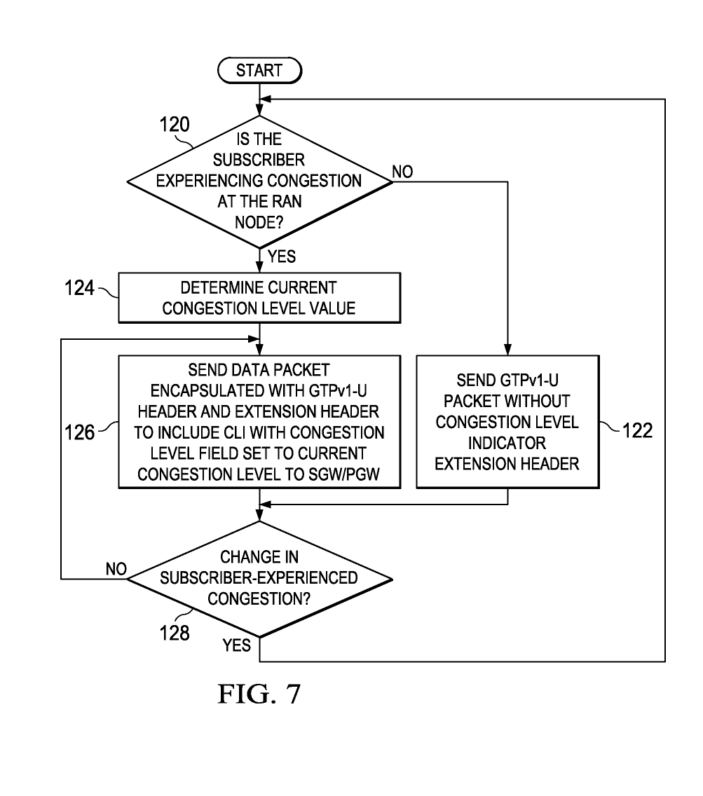

FIG. 7 illustrates a flowchart of RCLI logic executed at the RAN node 17 (using the processor 36, memory 38, and RAN congestion detection module 40) for indicating a congestion state, as well as a level of radio congestion, for a particular subscriber. The flow illustrated in FIG. 7 is periodically performed (e.g., at a pre-selected or programmable time interval or for every packet or once every designated number of packets) in connection with each subscriber individually. In step 120, a determination is made whether a congestion condition exists for the subscriber at the RAN. It will be recognized that there are any number of method of detecting subscriber congestion at the RAN node and that any one of these is acceptable for implementing step 120. If it is determined that the subscriber is not experiencing congestion, a CLI extension header is not provided in the uplink GTPv1-U packets for the subscriber in step 122. Conversely, if a determination is made in step 120 that the subscriber is experiencing congestion, in step 124, a current congestion level for the subscriber is determined. In one embodiment, the congestion level may range from 0, corresponding to no or minimal congestion, to 100, corresponding to maximum congestion. The congestion level may be identified in accordance with guidelines specified by the network operator. In step 126, if the uplink data packet for the subscriber is received at the RAN node while the congestion condition exists, the RAN node includes the CLI extension header with the GTPv1-U header carrying the data packet and forwards the encapsulated data packet to the SGW/PGW. The value in the Congestion Level field of the CLI extension header is set to the congestion level determined in step 124.

In step 128, which may be performed after a predetermined time interval has elapsed, a determination is made whether the congestion experienced by the subscriber has changed. If not, execution returns to step 126, in which the uplink data packets for the subscriber, when received, is provided with a GTPv1-U header and CLI extension header in which the value in the Congestion Level field remains unchanged. Conversely, if it is determined that the congestion experienced by the subscriber has changed, execution returns to step 120 and a determination is once again made whether the subscriber is experiencing congestion at the RAN node.

It should be noted that, if a congestion level of “0” corresponds to a situation in which no congestion is experienced by the subscriber, instead of omitting the CLI extension header from the GTPv1-U packet for the subscriber (step 122), the CLI extension header with a Congestion Level value set to “0” may be included instead. In this configuration, every GTPv1-U packet would include the CLI extension header, instead of only those packets being sent during a period of some level of RAN congestion.

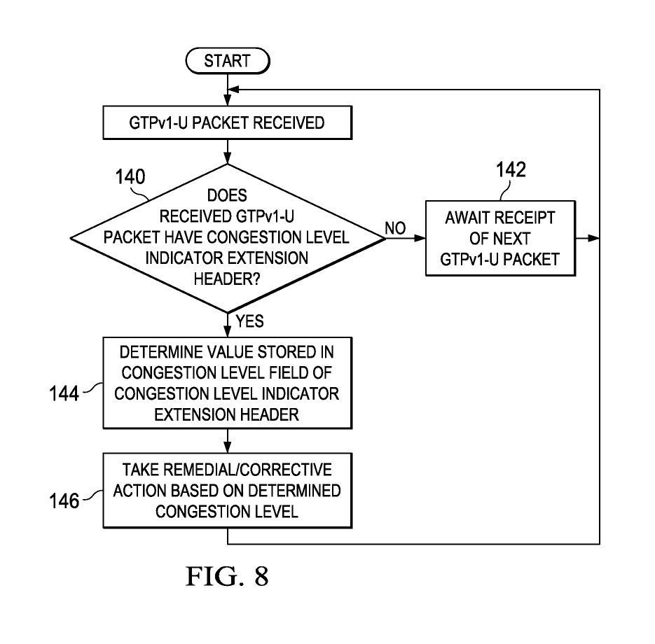

FIG. 8 illustrates a flowchart of RCLI logic executed at the PGW 28 (using the processor 30, memory 32, and RAN congestion control module 34) for responding to an indication of a RAN congestion for user plane traffic in connection with a particular subscriber. The flow illustrated in FIG. 8 is periodically performed (e.g., at a pre-selected or programmable time interval or for every packet or once every designated number of packets) in connection with each subscriber individually. For purposes of example, it will be assumed that the flow is executed in response to each uplink GTPv1-U packet received at the PGW 28. Accordingly, in step 140, in response to receipt of a GTPv1-U packet at the PGW, the packet is inspected to determine whether in includes a CLI extension header. If the received GTPv1-U packet does not include a CLI extension header, in step 142, no action is taken and receipt of the next subscriber packet is awaited, at which point, step 140 will be executed again. If, however, it is determined that the received packet does include a CLI extension header, in step 144, the value in the Congestion Level field of the CLI extension header is determined. In step 146, corrective, or remedial, action is taken based on the congestion level value recovered from the received packet. Such corrective, or remedial, action may include one or more of the following.

As described above, certain types of application data may be throttled for a certain period of time or the data traffic may be temporarily offloaded to a complementary network technology. For example, the PGW 28 may block or throttle traffic related to a particular service, such as YouTube video or Facebook video, for a particular period of time to reduce the amount of congestion being experienced by the subscriber for other applications. The PGW may feed the congestion level information to a video content server to request the video content server to change the encoding rate to adapt to the current congestion level; for example, during periods in which a subscriber is experiencing relatively little congestion, higher encoding rates can be used by the video content server, whereas during periods in which the subscriber is experiencing relatively high congestion, lower encoding rates can be used by the video content server, and thus the amount of bandwidth needed to transfer the content can be dynamically controlled by the current level of RAN congestion. In another alternative, the congested subscriber can be requested to upgrade its subscription level or top-up its subscription to a level that ensures better QoE than its current subscription level, to avail itself of an instant speed boost. In yet another alternative, if the PGW knows the identity of other subscribers in the same cell in which the congested subscriber is located, the PGW can change (specifically, downgrade) the QoS of those other subscribers (who are subscribed to lower subscription level than the congested subscriber) to ease congestion for the congested subscriber in the cell.

The action taken in step 144 may be dependent on the congestion level value being a particular value or falling within a range of values relating to a particular action. It will be recognized that, as described above with reference to FIG. 7, instead of being indicated by omission of a CLI extension header, a state of no congestion may be indicated by a congestion level value of “0”, in which case no corrective action would be taken. Additionally, although congestion level values of 0-100 have been described, it will be recognized that a less granular range of congestion level values, such as a range of 0-10, may also be advantageously employed.

Note that in certain example implementations, the RAN congestion level indication for user plane traffic functions outlined herein may be implemented by logic encoded in one or more tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory element, as shown in FIG. 1, can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor, as shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

In one example implementation, RAN node 17 and/or PGW 28 include software in order to achieve the RAN congestion level indication for user plane traffic functions outlined herein. These activities can be facilitated by modules 34, 40. Both RAN node 17 and/or PGW 28 can include memory elements for storing information to be used in achieving RAN congestion level indication for user plane traffic operations as outlined herein. Additionally, each of these devices may include a processor that can execute software or an algorithm to perform the RAN congestion level indication for user plane traffic activities as discussed in this Specification. These devices may further keep information in any suitable memory element (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory element.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that with the example provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures.

It is also important to note that the steps in the preceding flow diagrams illustrate only some of the possible signaling scenarios and patterns that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

In a separate endeavor, communication system 10 can generally be configured or arranged to represent the LTE architecture, the 3G architecture applicable to UMTS environments, or any suitable networking system or arrangement that provides a communicative platform for communication system 10. In other examples, FIG. 1 could readily include an SGSN, a gateway GPRS support node (GGSN), any type of network access server, network node, etc. Moreover, the present disclosure is equally applicable to other cellular and/or wireless technology including CDMA, Wi-Fi, WiMax, etc.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain backhaul links, AAA, and authentication protocols, communication system 10 may be applicable to other exchanges, routing protocols, authentication protocols, or routed protocols in which packets (not necessarily the routing protocol/packets described) are exchanged in order to provide RAN congestion level indication for user plane traffic activities. In addition, other example environments that could use the features defined herein include Pico architectures, where an appropriate RAN congestion level indication for user plane traffic could occur for UE 12.

What is claimed is:

1. A method, comprising:
receiving by a first network element a data packet associated with a subscriber;
determining a level of radio congestion currently experienced by the subscriber;
encapsulating the data packet in accordance with a first protocol, the encapsulating comprising adding a header to the data packet, the header including an extension header that includes a congestion level indicator (“CLI”) indicative of the determined level of radio congestion; and
forwarding the encapsulated data packet to a second network element.

2. The method of claim 1, wherein the extension header further includes an indication of whether the radio congestion currently experienced by the subscriber is in an uplink direction or a downlink direction.

3. The method of claim 1, further comprising:
receiving the encapsulated data packet at the second network element, the second network element evaluating the encapsulated data packet to determine the CLI; and
initiating corrective action to reduce the level of radio congestion experienced by the subscriber based on the CLI.

4. The method of claim 3, wherein the corrective action includes at least one of:
limiting subscriber data traffic associated with a particular application to improve quality of experience (“QoE”) of other applications;
offloading subscriber data traffic to a complementary network;
causing a server comprising at least one of an application server and a content server to change an encoding rate for the subscriber data traffic;
requesting the subscriber to upgrade its subscription; and
downgrading a subscription levels of other subscribers in a same cell as the subscriber.

5. The method of claim 3, wherein the receiving by a second network element comprises receiving by a PDN gateway (“PGW”).

6. The method of claim 1, wherein the receiving by a first network element comprises receiving by a radio access network node.

7. The method of claim 1, wherein the first protocol is GPRS Tunneling Protocol User Plane (“GTP-U”).

8. Logic encoded in one or more non-transitory tangible media that includes code for execution and when executed by a processor is operable to perform operations comprising:
receiving by a first network element a data packet associated with a subscriber;
determining a level of radio congestion currently experienced by the subscriber;
encapsulating the data packet in accordance with a first protocol, the encapsulating comprising adding a header to the data packet, the header including an extension header that includes a congestion level indicator (“CLI”) indicative of the determined level of radio congestion; and
forwarding the data packet to a second network element.

9. The logic of claim 8, wherein the extension header further includes an indication of whether the radio congestion currently experienced by the subscriber is in an uplink direction or a downlink direction.

10. The logic of claim 8, further operable to perform operations comprising:
receiving the encapsulated data packet at the second network element; and
causing the second network element to evaluate the encapsulated data packet to determine the CLI and initiate corrective action to reduce the level of radio congestion experienced by the subscriber based on the CLI.

11. The logic of claim 10, wherein the corrective action includes at least one of:
limiting subscriber data traffic associated with a particular application to improve quality of experience (“QoE”) of other applications;
offloading subscriber data traffic to a complementary network;
causing a server comprising at least one of an application server and a content server to change an encoding rate for the subscriber data traffic;
requesting the subscriber to upgrade its subscription; and
downgrading a subscription levels of other subscribers in a same cell as the subscriber.

12. The logic of claim 10, wherein the first network element comprises a radio access network (“RAN”) node and the second network element comprises a PDN gateway (“PGW”).

13. The logic of claim 8, wherein the first protocol is GPRS Tunneling Protocol User Plane (“GTP-U”).

14. An apparatus, comprising:
a memory element configured to store data;
a processor operable to execute instructions associated with the data; and
a RAN congestion level indication (“RCLI”) module configured to:
receive a data packet associated with a subscriber;
determine a level of radio congestion currently experienced by the subscriber;
encapsulate the data packet in accordance with a first protocol, the encapsulating comprising adding a header to the data packet, the header including an extension header that includes a congestion level indicator (“CLI”) indicative of the determined level of radio congestion; and
forward the data packet to a second network element.

15. The apparatus of claim 14, wherein the extension header further includes an indication of whether the radio congestion currently experienced by the subscriber is in an uplink direction or a downlink direction.

16. The apparatus of claim 14, further comprising a second RCLI module configured to:
receive the encapsulated data packet;
evaluate the encapsulated data packet to determine the CLI; and
initiate corrective action to reduce the level of radio congestion experienced by the subscriber based on the CLI.

17. The apparatus of claim 16, wherein the corrective action includes at least one of:
limiting subscriber data traffic associated with a particular application to improve quality of experience (“QoE”) of other applications;
offloading subscriber data traffic to a complementary network;
causing a server comprising at least one of an application server and a content server to change an encoding rate for the subscriber data traffic;
requesting the subscriber to upgrade its subscription; and
downgrading a subscription levels of other subscribers in a same cell as the subscriber.

18. The apparatus of claim 16, wherein the second RCLI module is associated with a PDN gateway (“PGW”).

19. The apparatus of claim 14, wherein the first RCLI module is associated with a radio access network (“RAN”) node.

20. The apparatus of claim 14, wherein the first protocol is GPRS Tunneling Protocol User Plane (“GTP-U”).
